(19) United States
(12) Patent Application Publication
(10) Pub. No.: US 2010/0139934 A1
(43) Pub. Date: Jun. 10, 2010

(54) Fire extinguisher enclosing countertop rack

(76) Inventor: Derrick McBounds, Detroit, MI (US)

Correspondence Address: JOHN R. BENEFIEL, 525 Lewis Street, BIRMINGHAM, MI, 48009, US

(21) Appl. No.: 12/317,260

(22) Filed: Dec. 22, 2008

Related U.S. Application Data
(60) Provisional application No. 61/008,367, filed on Dec. 20, 2007.

(51) Int. Cl. A62C 99/00

(52) U.S. Cl. 169/51

(57) ABSTRACT

A countertop rack includes an upright hollow housing having attachment features on the exterior on which are hung kitchenware or other items. A removable cap covers an open top of the housing which has a fire extinguisher received therein. Windows and/or notation on the housing make an observer aware of the presence of the fire extinguisher within the housing. The housing is preferably rotatable on the base to enable easy access to items disposed about the perimeter of the rack housing.

### CROSS REFERENCE TO RELATED APPLICATIONS

This application claims the benefit of U.S. provisional patent application No. 61/008,367 filed Dec. 20, 2007.

### BACKGROUND OF THE INVENTION

This application concerns storing of fire extinguishers of a compact type used for fire protection in residences to extinguish cooking fires and other small blazes. Keeping such fire extinguishers handy for emergencies has become widespread for obvious reasons.

The presence of these devices in the home presents aesthetic problems as its utilitarian design makes it desirable that they be out of sight. On the other hand, quick access is imperative in the event of a fire.

It is an object of the present invention to provide a concealed fire extinguisher which nonetheless is readily accessible for use in an emergency.

### SUMMARY OF THE INVENTION

The above recited object and other objects which will become apparent to those with knowledge of the art upon a reading of the following specification and claims are achieved by a countertop rack including an elongate upright hollow with an interior cavity configured to receive a compact home type fire extinguisher therein. The exterior of the housing is provided with features which are adapted to hang kitchen tools, implements, gadgets or other utensils or items thereon.

Preferably, the housing is rotatable on a base to enable a rotary movement to present all sides to a person to enable ready access to the items hung around the perimeter of the housing.

Access to the fire extinguisher is preferably afforded through an open top of the housing normally covered by a removable cap secured on the top of the housing.

Another desirable feature is the presence of one or more openings in the housing perimeter enabling viewing of a fire extinguisher within the housing creating a conspicuous visual presence so that a person not aware of its location will nonetheless be cued of that fact at a glance at the housing.

Additionally or alternatively, notation can be provided on the housing exterior informing an observer of the presence of the fire extinguisher within.

### DESCRIPTION OF THE DRAWING

FIG. 1 is a pictorial view of a first embodiment of countertop rack combined with a fire extinguisher according to the invention.

FIG. 2 is a pictorial view of a second embodiment of the invention.

FIG. 3 is a partially exploded pictorial view of the first embodiment of the invention.

FIG. 4 is an enlarged pictorial view of a cap for the first enclosure showing a notation thereon concerning the presence of the fire extinguisher.

### DETAILED DESCRIPTION

In the following detailed description, certain specific terminology will be employed for the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

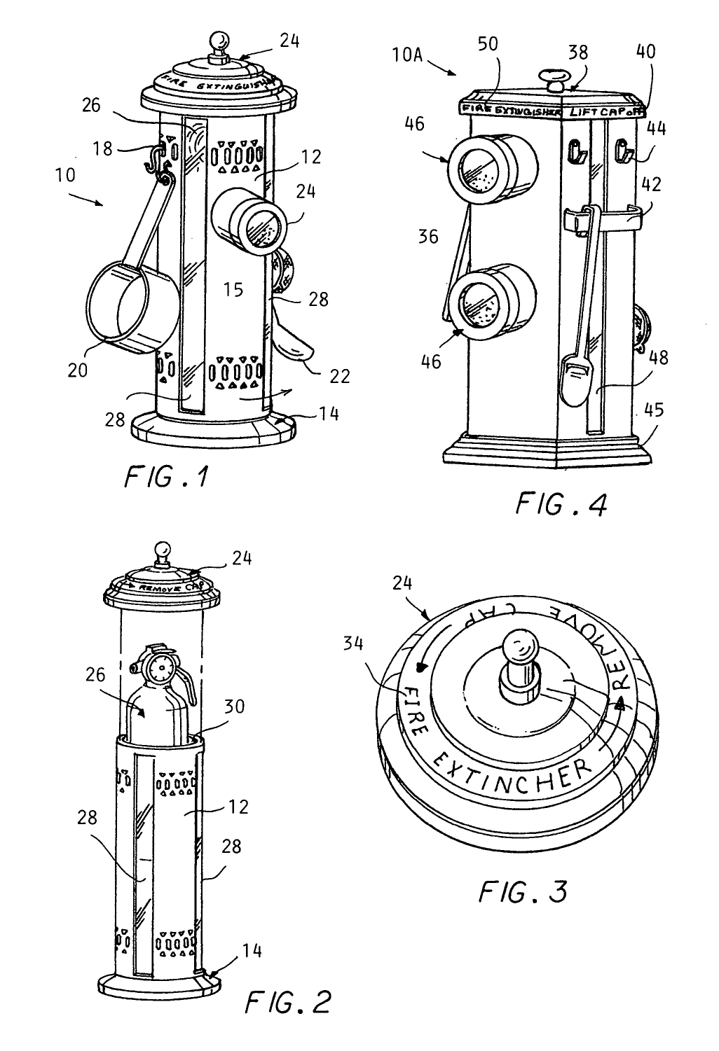

Referring to the drawings and particularly FIGS. 1-3, a countertop rack 10 is shown, comprising a generally cylindrical hollow housing 12 mounted on a base 14. The housing 12 is preferably rotatable on the base 14 so as to allow easy access to various tools, utensils, gadgets, implements, etc. 16 which may be hung on hooks 18 arranged around the exterior perimeter of the housing 12.

A series of slots, holes, or other features 20 may be provided to allow the hooks 18 to be held on the side wall 15 of the housing 12. The housing 12 may be made of sheet metal such as stainless steel, or plastic or other suitable materials.

The hooks 18 allow hanging utensils such as measuring cups 20, ladles 22, etc. on the exterior of the housing 12.

Another possibility are canisters 24 which have a magnet in its base allowing securement to sidewalls of the housing made of a magnetic material.

According to one aspect of the invention a removable cap 24 is normally positioned over an open top of the housing 12.

The cap 24 may be secured with rotary lock mechanical securement (not shown) of conventional design, or any other securement such as a magnetic retainer. This allows a compact fire extinguisher 26 to be inserted or removed from an internal cavity 30 after removal of the cap 24 as in FIG. 2.

In order to make persons aware of the presence of the fire extinguisher 26, a series of narrow vertical windows 28 can be provided, allowing viewing of the interior cavity 30 and the fire extinguisher 26 disposed therein.

In addition or alternatively, a notation 34 may be applied preferably to the top of the cap 26 as seen in FIG. 3.

FIG. 4 shows another embodiment of a countertop rack 10A an upright housing 36 is square shaped in section. A square cap 38 may have the notation 40 applied to side walls.

Alternative utensil fixed loop support elements 42, 44 are secured to the sides of the housing 36.

A square base 44 is provided which preferably also allows rotation of the housing 36.

Canisters 46 can be provided held with magnets to a side wall which is made of ferromagnetic material such as steel.

Alternatively magnets can be installed in a recess if non-magnetic material is used to construct the housing 36.

Narrow side windows 48 can be provided as in the above described embodiments to make apparent the presence of the fire extinguisher 26.

Notation 50 can also be used imprinted around the perimeter of the cap 36 notifying an observer of the presence of the fire extinguisher 28.

1. A counter top rack comprising:
an upright hollow housing having an internal cavity;
a series of item attachment features arranged about the exterior of said housing;
a removable cap on an open top of said housing; and
said housing configured to receive a compact fire extinguisher in said internal cavity in said housing through said open top.

2. The rack according to claim 1 wherein said housing has one or more windows enabling viewing of said fire extinguisher received therein.

3. The rack according to claim 1 further including in combination with a fire extinguisher in said housing cavity.

4. The rack according to claim 1 further including notation on said cap advising an onlooker of the presence of a fire extinguisher therein.

5. The rack according to claim 1 further including a base for said housing, said housing freely rotatable thereon.

6. The rack according to claim 1 further including in combination a plurality of kitchenware items hung on the exterior of said housing.

7. The rack according to claim 1 wherein said attachment features include one or more holes able to receive hooks therein.

8. The rack according to claim 1 wherein canisters are secured to said housing exterior by magnetic attraction.

9. The rack according to claim 1 further including a plurality of kitchenware items hung on said housing about the exterior thereof by said attachment features.

10. The rack according to claim 9 further including in combination a fire extinguisher in said housing cavity.

11. The rack according to claim 5 wherein one or more canisters are magnetically held on said housing sidewall.
